(19) United States
(12) Patent Application Publication
(10) Pub. No.: US 2008/0118893 A1
(43) Pub. Date: May 22, 2008

(54) Dental Implant Screw and Method of Use

(75) Inventors: Debora B. Armellini, Baltimore, MD (US); Mark E. Shirtliff, Columbia, MD (US); Alexander Pazoki, Bel Air, MD (US); Liene Molly, Baltimore, MD (US); Mark A. Reynolds, Baltimore, MD (US)

Correspondence Address: LARCHER & CHAO LLP, P.O. BOX 1666, SKOKIE, IL, 60076, US

(73) Assignee: UNIVERSITY OF MARYLAND, BALTIMORE, Baltimore (US)

(21) Appl. No.: 11/817,963

(22) PCT Filed: Mar. 7, 2006
(86) PCT No.: PCT/US06/08097

§ 371 Date: Jan. 11, 2008

Related U.S. Application Data
(60) Provisional application No. 60/659,124, filed on Mar. 7, 2005.
(60) Provisional application No. 60/737,086, filed on Nov. 16, 2005.

(51) Int. Cl. A61C 8/00

(52) U.S. Cl. 433/174

(57) ABSTRACT

An implantable dental screw comprising (i) an elongated body portion, which comprises a distal end and an external surface, which is axially threaded, (ii) a top portion, which is connected to the body portion at an end opposite to the distal end, and which comprises a proximal end, which comprises a seat that engages a tool for securing the screw into an osseotomy site and a chamfer that engages a dental prosthesis, and an external surface, (iii) at least one core channel disposed longitudinally within the screw and open at the proximal end and, optionally, at the distal end, and (iv) a plurality of delivery channels disposed within the body portion, each of which connects a core channel with the exterior of the screw; and a method of implanting the dental screw into a patient.

### CLAIM OF PRIORITY

This application claims priority to U.S. provisional patent application No. 60/659,124, which was filed on Mar. 7, 2005, and U.S. provisional patent application No. 60/737,086, which was filed on Nov. 16, 2005, both of which are hereby incorporated by reference in their entireties.

### TECHNICAL FIELD OF THE INVENTION

The present invention is directed to the field of dental devices, in particular a device that promotes osseointegration while reducing the risk of infection.

### BACKGROUND OF THE INVENTION

Endosseous dental implants are commonly used to support fixed or removable prostheses when a patient's natural roots have been lost and, consequently, there is insufficient support to provide adequate foundation for a dentition. An increase in the demand for implant dentistry has occurred, primarily due to increased retention of teeth in the aging population. In addition, the younger populations are opting for single implants over cutting down adjacent teeth to support a short-span bridge to replace a missing tooth. Therefore, more and more dentists are offering implant services to accommodate the increase in demand.

Screw-type implants are well-known in the art. For example, U.S. Pat. No. 3,499,222 to Linkow et al. discloses screw-type implants that can be buried in the alveolar ridge crest bone of a patient in an edentulous region. The implant has a threaded lower portion, which may be screwed into an opening created in the bone after the tissue has been displaced. A coronal portion protrudes above the bone and is used to support an artificial dental appliance, such as an artificial tooth or bridge.

In more recent years, submergible implants, in which the threaded portions of the implants can be completely embedded in the bone, have been developed. Such implants can be covered with tissue and allowed to remain in place, while new bone grows around the implant. Once the implant is firmly anchored in new bone, the tissue is reopened and an upper post portion is screwed into the implant portion and used to mount the artificial dental device.

Other implants, most of which are made using titanium, titanium alloy, aluminum oxide, vanadium or other inert metals, exist and have proven to be effective at fusing with living bone. This process is known as “osseointegration.” Most dental implants fail due to the nonoccurrence of osseointegration, leading to a loose and unattached implant. Other dental implants fail due to a perioperative infection. Infection at or near the site of insertion of a dental implant (either perioperative or postoperative) is resolved by a time-intensive and costly process. First, the implant is surgically removed, then the infection is allowed to heal, and finally, a new implant is inserted.

Therefore, there exists a need for improved dental implants. The present invention seeks to fulfill this need by providing a dental implant that can reduce the risk of infection, while promoting osseointegration, and thereby increasing implantation success. This and other objects and advantages, as well as additional inventive features, will become apparent from the detailed description provided herein.

### BRIEF SUMMARY OF THE INVENTION

The present invention provides an implantable dental screw. The screw comprises (i) an elongated body portion, which comprises a distal end and an external surface, which is axially threaded, (ii) a top portion, which is connected to the body portion at an end opposite to the distal end, and which comprises a proximal end, which comprises a seat that engages a tool for securing the screw into an osseotomy site and a chamfer that engages a dental prosthesis, and an external surface, the side of which is optionally at least partially axially threaded in register with the body portion, (iii) at least one core channel disposed longitudinally within the screw and open at the proximal end and, optionally, at the distal end, and (iv) a plurality of delivery channels disposed within the body portion, each of which connects a core channel with the exterior of the screw.

The present invention also provides a method of implanting the dental screw into a patient in need thereof. The method comprises (i) drilling a hole into the maxilla or mandible of the patient, wherein the hole comprises a side wall, (ii) optionally threading the side wall of the hole, (iii) tapping the screw into the hole, and (iv) securing the screw into the hole with a tool that engages the seat in the proximal end of the top portion of the screw until the body portion of the screw is completely inserted into the maxilla or mandible.

### BRIEF DESCRIPTION OF THE DRAWINGS

FIG. 1 is a schematic drawing of an embodiment of the implantable dental screw.

FIG. 2a is a schematic drawing of another embodiment of the implantable dental screw.

FIG. 2b is another schematic drawing of the embodiment of FIG. 2a showing the disposition of the core channel and the delivery channels within the screw.

FIG. 2c is a cross section of the embodiment of FIG. 2b taken at the line shown.

FIG. 3a is a graph of log 10 concentration of vancomycin (mg/l) vs. days showing the release of vancomycin from 90:10 PL:GC, 80:20 PL:GC, and 70:30 PL:GC.

FIG. 3b is a graph of log 10 concentration of tobramycin (mg/l) vs. days showing the release of tobramycin from 90:10 PL:GC, 80:20 PL:GC, and 70:30 PL:GC.

FIG. 3c is a graph of log 10 concentration of clindamycin (mg/l) vs. days showing the release of clindamycin from 90:10 PL:GC, 80:20 PL:GC, and 70:30 PL:GC.

FIG. 4 is a schematic of a prototype of the implantable dental screw.

FIG. 5 is a graph of concentration of tobramycin (μg/ml) vs. time (hours) showing the release of tobramycin from 70:30 PL:GC contained within the prototype of FIG. 4.

### DETAILED DESCRIPTION OF THE INVENTION

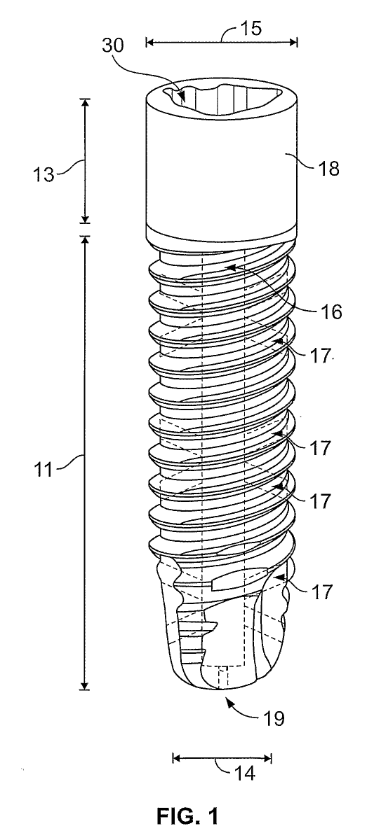

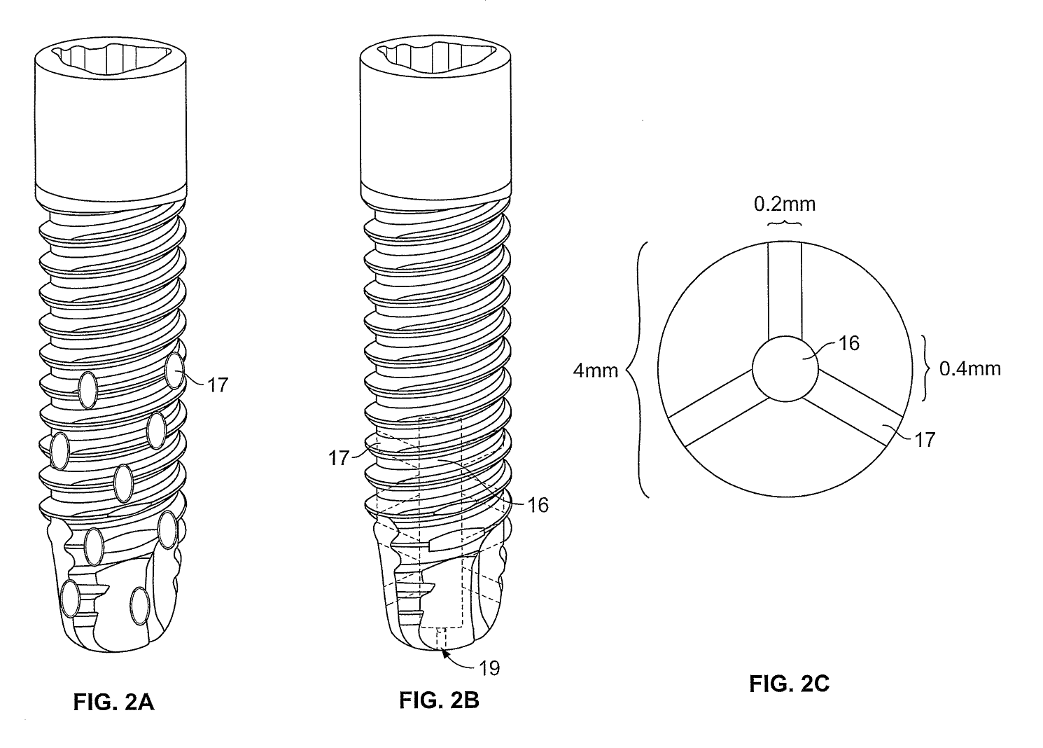

The present invention provides an implantable dental screw (FIG. 1). The screw comprises an elongated body portion (11), a top portion (13), at least one core channel (16), and a plurality of delivery channels (17). By “core channel” is meant one or more hollow tubular openings, which extend along a central longitudinal axis, preferably from the center of the proximal end (which is farther from the anteroposterior median plane when the implant is inserted) to the center of the distal end (which is closer to the anteroposterior median plane when the implant is inserted). The path of the core channel can be linear or traverse at a predetermined angle horizontal to a plane perpendicular to vertical. The core channel functions to store temporarily and/or facilitate delivery of a bioactive compound to the tissue surrounding the implant post-insertion. By “delivery channel” is meant one or more hollow tubular openings radiating outwardly from the core channel to the exterior of the screw. The elongated body portion comprises a distal end (14), which is preferably tapered as shown, for example, in FIG. 1, and an external surface, which is axially threaded. The top portion is connected to the body portion at an end opposite to the distal end, and comprises a proximal end (15) and an external surface (18). The proximal end comprises a seat (30) that engages a tool for securing the screw into an osseotomy site and a chamfer (also at 30) that engages, and preferably frictionally locks to, a dental prosthesis, such as by way of an adaptor or other connector. In this regard, the chamfer desirably is of sufficient size and depth to provide lateral stability to the dental prosthesis, such as by way of an adaptor or other connector, and desirably forms a smooth, easily cleaned margin with the dental prosthesis, such as by way of an adaptor or other connector. The seat can be wholly within the top portion or within the top portion and the elongated body portion, such as within the top portion and partially within the elongated body portion. The seat can have a configuration that engages an Allen wrench, for example. The side of the external surface of the top portion optionally can be at least partially axially threaded in register with the body portion. The at least one core channel (16) is disposed longitudinally within the screw and open at the proximal end and, optionally, at the distal end (19). The plurality of delivery channels (17) is disposed within the body portion. Each delivery channel connects a core channel with the exterior of the screw. Preferably, the implantable dental screw is self-tapping.

The implantable dental screw can have any dimensions, provided that the dimensions are suitable for implantation into a maxilla or a mandible. For example, the diameter of the top portion can range from about 2 mm to about 5 mm, such as 2, 3, 4, or 5 mm or diameters therein between, such as 2.25 mm. Likewise, the diameter of the elongated body portion can range from about 1 mm to about 2 mm, such as 1.1, 1.2, 1.3, 1.4, 1.5, 1.6, 1.7, 1.8 or 1.9 mm. Preferably, the diameter of the elongated body portion at the outside edge of the thread (the “outside thread diameter”) is at least about 2.5 mm. Similarly, the at least one core channel and the plurality of delivery channels can have any suitable dimensions. The diameter of a core channel can bear a relationship to the diameter of the top portion, e.g., a diameter about 1/10th of the diameter of the top portion, such as 0.4 mm is in relation to 4 mm, or the diameter of the at least one core channel can have a diameter that is independent of the diameter of the top portion. Preferably, the diameter of the at least one core channel is not so small that agents cannot pass through the channel and not so large that the structural integrity of the implantable dental screw is compromised in any way. Preferably, the diameter of the at least one core channel is at least about 0.1 mm. The core channel can run from the distal end to the proximal end, taking into consideration the presence of the seat and the chamfer. For example, the core channel can be 6, 7, or 8 mm in length. The diameter of a delivery channel preferably is about 0.1 mm to about 0.3 mm, more preferably about 0.2 mm to about 0.3 mm, and most preferably about 0.25 mm in outside diameter. Preferably, the delivery channels radiate outwardly at an angle relative to the core channel, preferably from about 10° to about 35°, more preferably from about 15° to about 30°, and most preferably at about 20° to about 25°, e.g., 20°, from a horizontal plane that transects the core channel. Also preferably, the delivery channels are positioned in different directions, such as towards the proximal end and towards the distal end, such that the channels achieve delivery of the contents of the at least one core channel to the exterior of the screw when the screw is implanted in the maxilla or the mandible. In this regard, there can be more than one delivery channel in a single plane, such as two, three or more delivery channels. The core and delivery channels can be of uniform and/or non-uniform shape and/or size. Thus, the core channels and/or the delivery channels can have the same or substantially the same diameter and/or shape. Alternatively, one core/delivery channel can have one diameter and another core/delivery channel can have another diameter. Preferably, the diameter of the core channel also allows for the passage of blood and the growth of tissue into the channel.

The implantable dental screw can be manufactured in accordance with methods known in the art. In this regard, the elongated body portion and the top portion can be manufactured as a single piece or as separate pieces that are subsequently joined together. Preferably, the screw is made from a biocompatible material. By “biocompatible material” is meant a material that interacts favorably with a biological system and does not cause a local or a systemic, including an acute or a chronic, inflammatory reaction following implantation. Optimally, the material does not interfere with the normal healing process and is not rejected by the patient's body. Examples of biocompatible materials include, but are not limited to, metal, ceramic, glass, or a combination thereof. Preferred metals include titanium, titanium alloy, vanadium, aluminum oxide, and the like.

In view of the above, the present invention provides a method of implanting the dental screw into a patient in need thereof. The method comprises drilling a hole into the maxilla or mandible of the patient, optionally threading the side wall of the hole, tapping the screw into the hole, and securing the screw into the hole with a tool that engages the seat in the proximal end of the top portion of the screw until the body portion of the screw is completely inserted into the maxilla or mandible. A pilot drill and two internally irrigated, end-cutting drills of progressively increasing diameter can be used to drill the hole. The side wall of the hole can be threaded when the bone is dense. A titanium bone tap device can be used for such a purpose. When the screw is properly inserted into the maxilla or mandible, the body portion seals the opening through the cortical bone, simplifies any subsequent uncovering procedure, and provides a smooth, easily cleaned, supracortical connection to a matching, chamfered edge on a dental prosthesis.

The method can, and preferably does, further comprise introducing a bioactive compound, alone or in combination with a pharmaceutically acceptable carrier, into the core channel, such as by way of the proximal end. If desired, the bioactive compound, alone or in combination with a pharmaceutically acceptable carrier, can be introduced prior to introduction of the screw into the maxilla or mandible. By “bioactive compound” is meant a compound that promotes healing, promotes bone formation, and/or inhibits microbial colonization and infection.

Bioactive compounds that are useful in the context of filling osteotomy sites are known in the art. Examples include, but are not limited to, natural and synthetic antibiotics, such as tobramycin, penicillin, tetracycline, aminoglycoside, quinolone, metronidazole, aztreonam, merepenem, imepenem, chloramphenicol, clindamycin, cephalosporin, macrolide, minocycline, doxycycline, glycopeptides, trimethoprim, sulfamethoxazole, fusidic acid, quinupristin/dalfopristin, metronidazole, rifampin, unisyn, amphenicol, ansamycin, β-lactam, lincosamide, polypeptide, 2,4-diaminopyrimidine, nitrofuran, sulfonamide, sulfone, and derivatives thereof. Other examples, including additional examples of the preceding classes of compounds, can be found in the Merck Index, 12th edition, particularly in the Therapeutic Category and Biological Activity Index. Other examples of bioactive compounds include, but are not limited to, bone morphogenetic protein-1, -2, -4, and -7, epidermal growth factor, fibroblast growth factor 2, nerve growth factor, platelet-derived growth factor, placental growth factor, transforming growth factor, vascular endothelial growth factor, insulin-like growth factor I, antimicrobial agents, defensins, platelet (PLT)-rich plasma, transforming growth factor-β1 and -β2, enamel matrix derivative, amelogenins, parathyroid hormone, steroid hormones, estrogen, core binding factor α-1, osteocalcin, hepatocyte growth factor, bovine-derived bone morphogenetic protein extract, autologous growth factors, anti-inflammatory agents, cytokines, osteoclast inhibitors, bisphosphonates, etc., or combinations of the foregoing.

Any suitable pharmaceutically acceptable carrier can be used as known in the art. “Pharmaceutically acceptable carrier” includes any and all solvents, dispersion media, coatings, anti-bacterial agents, anti-fungal agents, anti-viral agents, isotonic and absorption-delaying agents, and the like. Specific examples include calcium phosphate, poly-L-lysine, polyethylene glycol, poly(glycolide), poly(-lactide), poly(lactide-co-glycolide), fibrin, calcium hydroxyapaptite, polylactic acid, ethyl cellulose, alginate, bisphosphonates, novel hydrogel composites, based on the biodegradable polymer, oligo(poly(ethylene glycol) fumarate) (OPF), collagen, and polymeric micelles consisting of poly(ethylene oxide)-b-poly(propylene oxide), poly(ethylene oxide)-b-poly(ester)s and poly(ethylene oxide)-b-poly(amino acid), poly(propylene fumarate), pro-drug polymers, chitosan, zinc sulfate calcium phosphate ceramic, neutralized glass-ceramics, carbohydrate-stabilized ceramics, silica, silica-based sol-gel, bone, sintered bone, solvent dehydrated bone, aluminosilicate ceramics, cellulose, hydroxypropylcellulose, hydroxymethylcellulose, coralline, coral exoskeleton, silica-calcium phosphate composites, polymethacrylate methylene, collagen/hydroxyapatite composite, etc., and any composite formulations or combinations of the foregoing. See, e.g., Remington: The Science and Practice of Pharmacy, Lippincott, Williams & Wilkins, 21st ed., May 28, 2005. The carrier should be compatible with the bioactive compound. Preferably, the carrier is inert and absorbed by the tissue at the site of implantation. Other active agents, excipients, carriers, adjuvants and the like, also can be combined with the bioactive compound. Preferably, a carrier is selected in accordance with the method set forth herein.

The type and concentration of bioactive compound, as well as the type and concentration of pharmaceutically acceptable carrier, used depend in part on the particular patient. For example, the choice of bioresorbable polymer can be tailored to the specific needs of the patient to enable time-release of impregnated material at variable rates. Preferably, a composition of bioactive compound and pharmaceutically acceptable carrier comprises about 5% to about 75% by weight of the bioactive compound.

The method of implanting the dental screw can still further comprise connecting a dental prosthesis, such as by way of an adaptor or other connector, to the proximal end of the top portion. The connection of a dental prosthesis is within the ordinary skill in the art.

The method can promote osseointegration, inhibit infection associated with normal implantation procedures in uninfected patients, and treat infection in re-implantation procedures following implantitis in patients. At the same time, the method minimizes systemic exposure of the patient to the bioactive compound.

### EXAMPLES

The following examples serve to illustrate the present invention and are not intended to limit its scope in any way.

### Example 1

This example describes a method of determining an optimal carrier.

In order to ensure a high, sustained, local delivery of antibiotics, the antibiotic of choice will have to be embedded within a polymer that elutes at an optimal rate. Therefore, the elution characteristics of a number of different polymers presently approved for use in humans were evaluated. The six types of carrier substances that were tested included non-biodegradable polymethylacrylate (PMMA) (Howmedica Inc., Houston, Tex.), biodegradable PLA (Polysciences Inc., Warrington, Pa.) with a molecular weight (MW) of 2,000, varied ratios of biodegradable PL:CG (Polysciences Inc., Warrington, Pa.) of 90:10, 80:20 and 70:30, and a combination of the PLA and the 70:30 ratio of PL:CG. In order to account for the differences in clinical dosages for each of the antibiotics tested, each antibiotic used in the study was employed in a ratio of grams antibiotic:grams bead material at levels of 1:6.6, 1:4.1, and 1:10.0 for clindamycin, tobramycin, and vancomycin, respectively, as per manufacturer's directions. Eight millimeter PMMA, PLA, PL:CG and the combination PLA-PL:CG beads were constructed, dried overnight, sterilized with γ-radiation for three days, and weighed. The beads' masses ranged from 0.35 to 0.40 grams.

One bead of each antibiotic/bead combination was placed in one milliliter of phosphate-buffered saline (PBS, pH 7.2) and incubated at 37° C. for 24 hours. The beads were removed, shaken free of excess PBS, and transferred to fresh one milliliter aliquots of PBS every 24 hours and incubated. The samples of removed PBS were stored at −70° C. until a microbiological disc diffusion assay could be performed. Disc diffusion assays were performed to determine antibiotic concentrations in the samples. For tobramycin and vancomycin, 0.1 milliliter of Bacillus subtilis spore suspension (Difco, Detroit, Mich.) was added per 100 milliliters of the Antibiotic Agar Medium One (Difco). The bioassay for clindamycin differed slightly from those for tobramycin and vancomycin. To each 18 milliliter of sterile liquefied antibiotic Media One (Difco), 0.4 milliliter of an overnight culture of Sarcina lutea (ATCC 9341) was added. Five milliliters of this seeded agar were aseptically pipetted into petri dishes. Standard two-fold serial dilutions were made in PBS for tobramycin and vancomycin, producing standard concentrations ranging from 10,000-0.1 mg/l. Twenty microliters of each in vitro sample and standard concentration were added to each of four sterile, blank, six millimeter diameter Bacto Concentration Disks (Difco), and these were placed on the seeded plates. The plates were incubated overnight at 37° C. The diameter of the zones of inhibition for each standard and in vitro PBS sample was measured. The unknown concentration for the in vitro samples were determined by comparing their respective zone size means to the standards.

The antibiotic concentrations at the transition point between bacterial killing and resistance to the antibiotic (the break point sensitivity limit) for the three antibiotics were determined utilizing tube dilution sensitivities. All studies were performed in quadruplicate. Statistical comparison of dissolution rates of the various biodegradable bead types was accomplished using a Student's t-test.

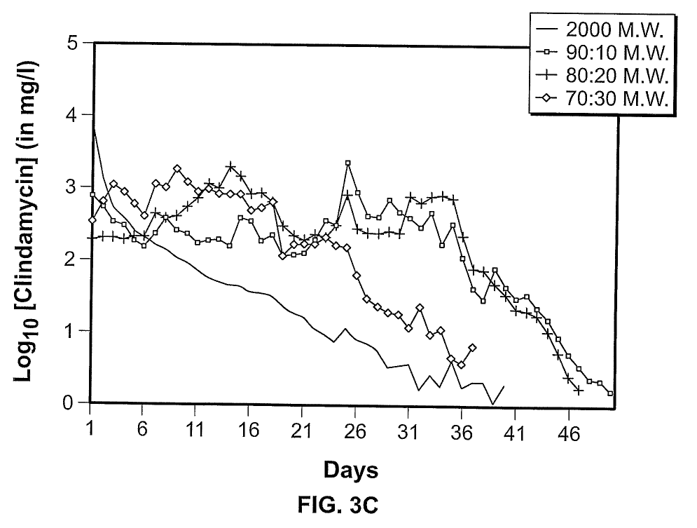

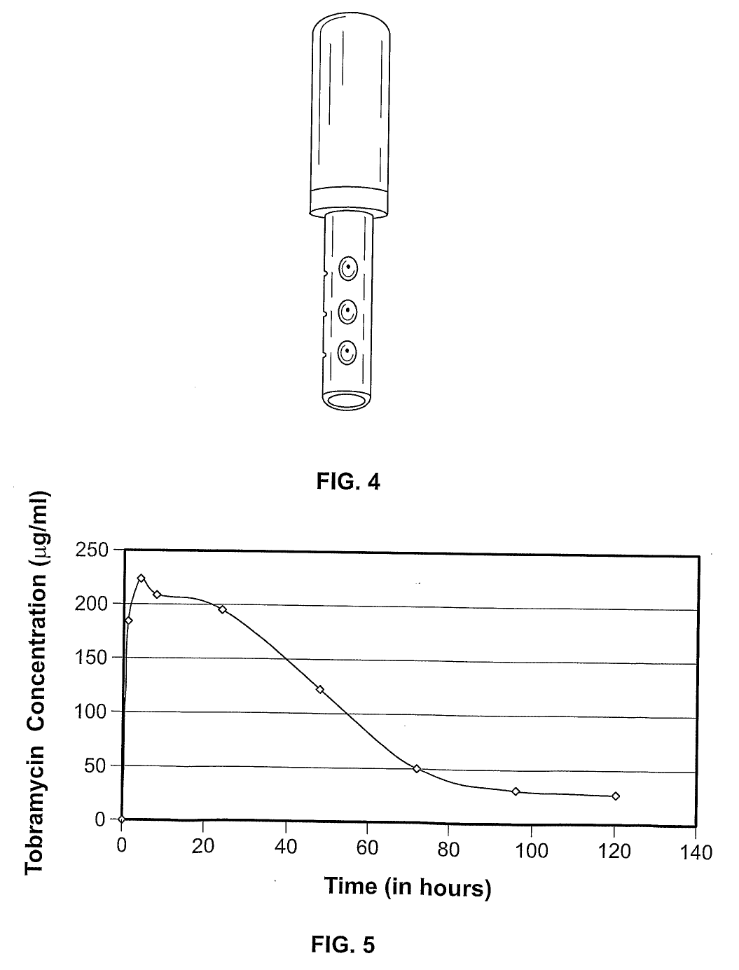

As with a previous orthopaedic study of antibiotic elution (Shirtliff, et al., Clin. Orthop. 239-247 (2002)), we defined the best carrier formulation as one that provided antibiotic concentrations above the breakpoint sensitivities for four to six weeks, did not produce toxic serum concentrations, did not provide a long term, low level of antibiotic elution below breakpoint sensitivity, and effectively eluted each of the antibiotics tested. The best bead formulation that matched these criteria was the 70:30 ratio of PL:CG (see FIG. 4 for antibiotic elution profiles for all three antibiotics). Therefore, this mixture was used as the carrier substance for all subsequent studies.

### Example 2

This example describes the development of an animal model.

After finding the optimal carrier substance formulation, we determined if the proposed carrier substance could also deliver effective concentrations in vivo in a worst case scenario situation. Therefore, the formulation was used to treat an active chronic infection in a localized osteomyelitis model in 2 to 3 kg female New Zealand White rabbits. The localized osteomyelitis model was a combination of Fitzgerald's dog model and Shirtliff and Mader's rabbit model (Fitzgerald, J. Bone Joint Surg. [Am.] 65:371-380 (1983); Mader et al., p. 581-591. In Zak and Sande (ed.), Handbook of Animal Models of Infection. Academic Press Ltd., London, England (1999); Shirtliff et al., J. Antimicrob. Chemother. 48:253-258 (2001); Shirtliff et al. (2002), supra; Shirtliff et al., Antimicrob. Agents Chemother. 46:231-233 (2002); and Shirtliff et al., Clin. Orthop. 359:229-236 (1999)).

A biodegradable antibiotic bead delivery system was developed using PL:CG. As mentioned previously, varied degradation rates and antibiotic elution rates were achieved by changing the molecular weight of polylactic acid and varying the ratios of polylactic acid, poly-DL-lactide, and co-glycolide. The PL:CG bead used in this study was made up of a 70:30 ratio of poly-DL-lactide:co-glycolide. This molecular weight and these ratios were selected because, when combined with vancomycin, this bead produced an adequate bactericidal concentration of 5.0 μg/mL (the transition concentration between bacterial killing and resistance to the antibiotic) and dissolved in just over 6 weeks in saline shaker bath elution tests. Ten grams of PL:CG were combined with 1 gram vancomycin powder and then methylene chloride was added to solubilize the PL:CG and vancomycin. The gel mixture was dried in a sterile vacuum hood until it could be molded into 6 mm diameter spheres with an approximate mass of 1.5 g per bead. The beads were allowed to dry overnight and were sterilized by γ-radiation (1.5 megarads) for 8 hours.

The strain of S. aureus was obtained from Dr. Peter Rissing (Medical College of Georgia, Augusta, Ga.). This strain belongs to phage type 52/52A/80, is coagulase positive, and forms a yellow pigment on Tryptic Soy Agar II 5% defibrinated sheep's blood agar. The organism was grown overnight in trypticase soy broth, washed, and resuspended in saline. The organism was lyophilized and stored, and rehydrated samples of this strain were used throughout this study.

The minimum inhibitory concentration of vancomycin to S. aureus was determined using an antibiotic tube dilution method in Cation Supplemented Muller-Hinton Broth (CSMHB) (Difco). Vancomycin was serially diluted, 2-fold, in tubes containing 0.5 milliliters of CSMHB. The S. aureus inocula for a series of tubes was 0.5 mL of a 5.0×10⁵ colony forming units per milliliter dilution of an overnight culture. The minimum inhibitory concentration was considered to be the lowest concentration of antibiotic that prevented turbidity after 24 hours of incubation at 37° C. After the minimum inhibitory concentration was determined, 0.01 mL of each clear tube was streaked onto the surface of a blood agar plate. The minimum bactericidal concentration was the lowest concentration of antibiotic that resulted in 10 or fewer colony forming units on the plate after 24 hours of 37° C. incubation.

A localized S. aureus osteomyelitis was surgically induced in the left lateral tibial metaphysis of all rabbits within all study groups. One colony forming unit of S. aureus was incubated overnight in CSMHB at 37° C. The bacterial concentration of the culture was adjusted to 0.5 McFarlands (10⁸ colony forming units per milliliter) using a turbidimeter (Abbott Laboratories, Chicago, Ill.). The culture was further diluted in 0.85% saline to a final concentration of 10⁵ colony forming units per milliliter. A 1 to 1 ratio of sterile pulverized rabbit bone to bacterial solution was prepared to produce a slurry of pulverized bone containing S. aureus. Rabbits were anesthetized with an intravenous injection of Ketalar (Parke Davis Laboratories, Morris Plains, N.J.) and Promace (Ayerst Laboratories, New York, N.Y.) solution. The left leg of the animal was shaved and prepared for surgery under standard aseptic conditions. A circular 4 mm diameter defect was induced in the lateral aspect of the left tibial metaphysis using a surgical drill equipped with a 4 mm burr. One hundred microliters of the bacterial slurry were packed into the intramedullary canal with a 1 mL syringe. The hole was capped with polymethylmethacrylate bone cement (Howmedica, Inc, Rutherford, N.J.) to minimize soft tissue infection. The infection was allowed to progress for 2 weeks, at which time the severity of osteomyelitis was determined radiographically.

At 2 weeks postinfection, the 96 rabbits with localized proximal tibial osteomyelitis were separated into 8 study groups, each containing 12 rabbits. Each group contained the following: (Group 1—nontreated control rabbits) (Group 2—rabbits to be treated by débridement only) (Group 3—rabbits to be treated only with systemic vancomycin) (Group 4—rabbits to be treated with débridement and systemic vancomycin) (Group 5—rabbits to be treated with débridement and vancomycin loaded PL:CG beads) (Group 6—rabbits to be treated with débridement and plain (no vancomycin) PL:CG beads) (Group 7—rabbits to be treated with débridement, vancomycin PL:CG beads, and systemic vancomycin) (Group 8—rabbits to be treated with débridement, plain (no vancomycin) PL:CG beads, and systemic-vancomycin. After the animals were placed in treatment groups, the bone cement plug was removed from the defect of all rabbit groups except Groups 1 and 3 using a curette. Necrotic tissue was then debrided from within the defect and from the surrounding soft tissue in all rabbit groups except Groups 1 and 3. Depending on the group, four plain or vancomycin-loaded PL:CG beads were packed into the debrided defect. Treatment for the animals of each group lasted 28 days (42 days after infection), at which time, animals were sacrificed and all tibias were harvested for bone S. aureus concentration determination. The systemic vancomycin was to be given at 30 mg/kg body weight every 12 hours, subcutaneously. The animals in each group were to be treated for 28 days.

Quantitative counts of S. aureus colony forming units per gram of tibial bone were determined for all study groups. After animals were sacrificed, the tibia was stripped free of all soft tissue, broken into large fragments, and all adhering bone marrow was removed. The large bone fragments were pulverized in a bone mill (Brinkmann Instruments, Westbury, N.Y.), and the final product weighed. Physiologic 0.85% saline was added to the pulverized bone in a 3 to 1 ratio (3 ml saline/gram of bone), and the suspension was vortexed for 5 minutes. Five 10-fold dilutions of each of the saline and bone suspensions were prepared with sterile 0.85% (weight to volume) NaCl solution. One hundred milliliter samples of each of the five dilutions were streaked onto blood agar plates and incubated at 37° C. for 24 hours. Colony forming units were then counted for each tibia sample. The mean log of the colony forming units for the five plates was calculated and the mean S. aureus concentration for each treatment group was calculated.

Treatment with antibiotic containing PL:CG beads, either with or without systemic vancomycin, resulted in levels of 10^{2.93} and 10^{2.84} colony forming units per gram bone, respectively. These bacterial concentrations were significantly lower than those observed for all other treatment groups (controls=10^{4.55} colony forming units per gram bone, debridement alone=10^{4.53} colony forming units per gram bone, systemic vancomycin alone=10^{4.57} colony forming units per gram bone, debridement with systemic vancomycin=10^{4.52} colony forming units per gram bone, PL:CG beads not loaded with vancomycin plus debridement=10^{4.34} colony forming units per gram bone, and systemic vancomycin with PL:CG beads not loaded with vancomycin plus debridement=10^{5.00} colony forming units per gram bone (p<0.05)). Therefore, this material could deliver local levels of antibiotics to treat effectively an active infection. As a result, we determined that the material would be especially effective in preventing bacterial colonization and the subsequent development of an infection.

### Example 3

This example describes testing of a prototype of the implantable dental screw.

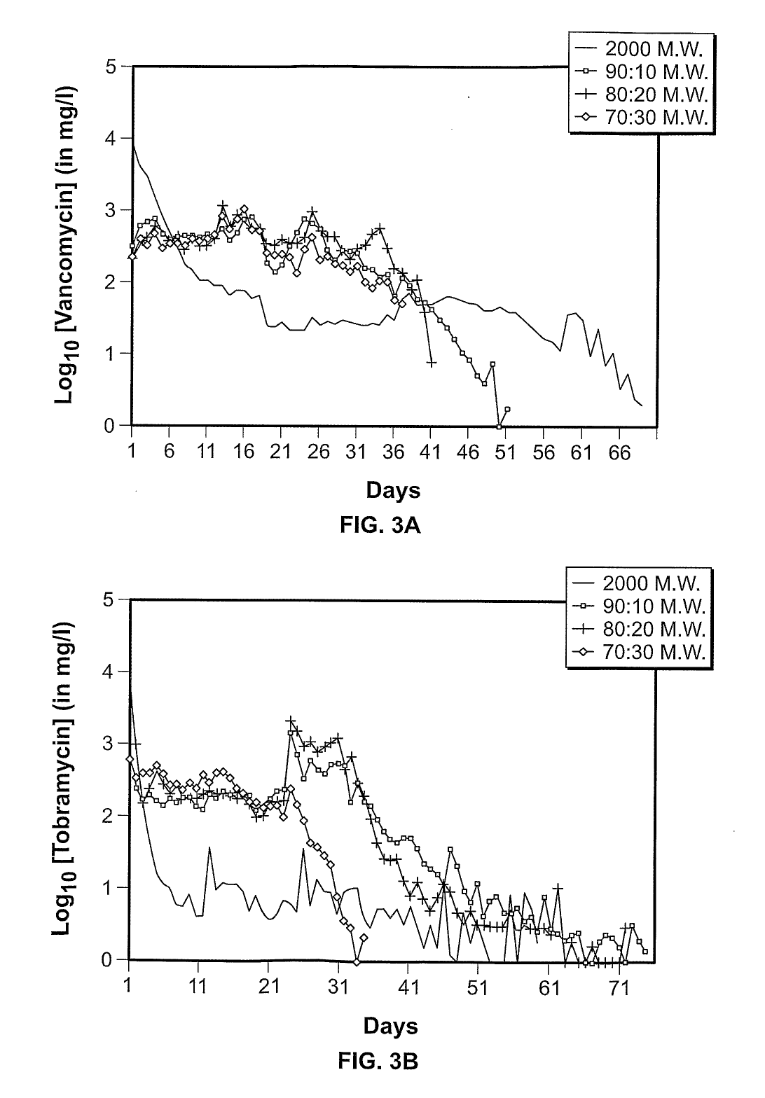

We designed and fabricated several prototypes to test the principle of antibiotic elution from small channels that were machined into implants. The channels were designed to be small enough to not impact the structural integrity of the implant but elute enough antibiotics for 3-4 weeks post-surgery. Once the implant prototypes were machined, we combined the 70:30 PL:CG with tobramycin at a ratio of antibiotic to carrier substance of 1:4.1. This mixture was then combined with acetone until a viscous mixture was attained and then injected into the small channels of the implant prototype (see FIG. 1). Each of the implants was placed in one milliliter of phosphate-buffered saline (PBS, pH 7.2) and incubated at 37° C. Small samples (i.e. 20 μl) were taken 4, 8, and 12 hours after submerging the implant in PBS. Every 24 hours, the implants were removed, shaken free of excess PBS, and transferred to fresh one milliliter aliquots of PBS and incubated. The samples of removed PBS were stored at −70° C. until a microbiological disc diffusion assay could be performed. Disc diffusion assays were performed to determine antibiotic concentrations in the samples as described above. In the first 120 hours of the study (see FIG. 3b), the tobramycin elution from the implant was significantly (p<0.05) lower than elution from the bead material. This was to be expected since the antibiotic amount carried within the implant (i.e., 1500 μg of active tobramycin) was more than a factor of 10 lower than that contained within the bead. However, the initial burst of antibiotic from the implant in the first 48 hours was over 50 times the concentration that is attained in the serum during systemic antibiotic therapy. Nearly 25% of the total antibiotic eluted from the implant during this early burst. Daily samples continued to be harvested, and the PBS changed. The remaining 75% of the antibiotic eluted from the implant in the subsequent 20-24 days, maintaining the post-burst elution level that is over 5 times the concentration seen during systemic therapy. Therefore, the antibiotic-impregnated dental implant released a very high burst of antibiotics to kill those bacteria introduced during implantation. In addition, the sustained, long term (i.e. 30-60 days post-surgery) antibiotic levels are much higher than the levels that can be obtained with systemic antibiotics, enabling the clearance of any transient colonization that might occur in the subsequent post-surgery period. This effective delivery can be accomplished without systemically exposing the patient to these high levels of antibiotics.

### OTHER REFERENCES

### Dunn, C. et al., “BMP Gene Delivery for Alveolar Bone Engineering at Dental Implant Defects,” Mol Ther. 11(2):294-299 (February 2005).

### Cochran D. et al., “Recombinant Human Bone Morphogenetic Protein-2 Stimulation of Bone Formation Around Endosseous Dental Implants,” J. Periodontol 70(2):139-150 (February 1999).

### Marx et al., “Platelet-rich plasma (PRP): what is PRP and what is not PRP?” Implant Dent. 10(4):225-228 (2001).

Boyne et al., “A feasibility study evaluating rhBMP-2/absorbable collagen sponge for maxillary sinus floor augmentation,” Int. J. Periodontics Restorative Dent 17(1): 11-25 (February 1997).
Marx et al., “Platelet-rich plasma: Growth factor enhancement for bone grafts,” Oral Surg Oral Med. Oral Pathol. Oral Radiol. Endod 85(6):638-46 (June 1998).
Nijhof et al., “Prophylaxis of implant-related staphylococcal infections using tobramycin-containing bone cement,” J. Biomed. Mater. Res. 52:754-761 (2000).
Nijhof et al., “Release of tobramycin from tobramycin-containing bone cement in bone and serum of rabbits,” J. Mats. Sci: Mats. in Med. f:799-802 (2003).
Nijhof et al., “Prevention of infection with tobramycin-containing bone cement or systemic cefazolin in an animal model,” J. Biomed. Mater. Res. 52:709-715 (2000).
Persson et al., “The economics of preventing revisions in total hip replacement,” Acta Orthop. Scand. 70:163-169 (1999).
Murray, “Use of antibiotic-containing bone cement,” Clin. Orthop.: 89-95 (1984)
Nelson et al., “The effect of antibiotic additions on the mechanical properties of acrylic cement,” J. Biomed. Mater. Res. 12:473-490 (1978).
Lynch et al., “Deep infection in Charnley low-friction arthroplasty. Comparison of plain and gentamicin-loaded cement,” J. Bone Joint Surg. Br. 69:355-360 (1987).
Malchau et al., “Prognosis of total hip replacement in Sweden. Follow-up of 92,675 operations performed,” Acta Orthop. Scand. 64:497-506 (1978-1990).
Thierse, “Experiences with Refobacin-Palacos with regard to deep late infections following hip-joint endoprosthesis surgery. A 4-years' study (author's transl),” Z. Orthop. Ihre Grenzgeb. 116:847-852 (1978).
Havelin et al., “The effect of the type of cement on early revision of Charnley total hip prostheses. A review of eight thousand five hundred and seventy-nine primary arthroplasties from the Norwegian Arthroplasty Register,” J. Bone Joint Surg. Am. 77:1543-1550 (1995).
Klekamp et al., “The use of vancomycin and tobramycin in acrylic bone cement: biomechanical effects and elution kinetics for use in joint arthroplasty,” J. Arthroplasty 14:339-346 (1999).
Buchholz et al., “Antibiotic-loaded acrylic cement: current concepts,” Clin. Orthop.: 96-108 (1984).
U.S. Pat. No. 3,499,222 “Intra-Osseous Pins and Posts and Their Use and Techniques Thereof”
U.S. Pat. No. 4,960,381 “Screw-Type Dental Implant Anchor”
U.S. Pat. No. 5,711,669 “High Load Factor Titanium Dental Implant Screw”
U.S. Pat. No. 6,174,167 “Bioroot Endosseous Implant”
U.S. Pat. No. 6,273,720 “Dental Implant System”
U.S. Pat. No. 6,283,754 “Bioroot Endosseous Implant”
U.S. Pat. No. 6,648,643 “Dental Implant/Abutment Interface and System Having Prong and Channel Interconnections”
U.S. Reissue Pat. No. RE35,784 “Submergible Screw-Type Dental Implant and Method of Utilization”

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An implantable dental screw, which comprises:
(i) an elongated body portion, which comprises a distal end and an external surface, which is axially threaded,
(ii) a top portion, which is connected to the body portion at an end opposite to the distal end, and which comprises a proximal end, which comprises a seat that engages a tool for securing the screw into an osseotomy site and a chamfer that engages a dental prosthesis, and an external surface, the side of which is optionally at least partially axially threaded in register with the body portion,
(iii) at least one core channel disposed longitudinally within the screw and open at the proximal end and, optionally, at the distal end, and
(iv) a plurality of delivery channels disposed within the body portion, each of which connects a core channel with the exterior of the screw.

2. The implantable dental screw of claim 1, which is self-tapping.

3. The implantable dental screw of claim 1, wherein the seat is internal to the proximal end.

4. The implantable dental screw of claim 3, wherein the seat has a configuration that engages an Allen wrench.

5. A method of implanting a dental screw into a patient in need thereof, wherein the dental screw comprises (a) an elongated body portion, which comprises a distal end and an external surface, which is axially threaded, (b) a top portion, which is connected to the body portion at an end opposite to the distal end, and which comprises a proximal end, which comprises a seat that engages a tool for securing the screw into an osseotomy site and a chamfer that engages a dental prosthesis, and an external surface, the side of which is optionally at least partially axially threaded in register with the body portion, (c) at least one core channel disposed longitudinally within the screw and open at the proximal end and, optionally, at the distal end, and (d) a plurality of delivery channels disposed within the body portion, each of which connects a core channel with the exterior of the screw, which method comprises:
(i) drilling a hole into the maxilla or mandible of the patient, wherein the hole comprises a side wall,
(ii) optionally threading the side wall of the hole,
(iii) tapping the screw into the hole, and
(iv) securing the screw into the hole with a tool that engages the seat in the proximal end of the top portion of the screw until the body portion of the screw is completely inserted into the maxilla or mandible,
whereupon the dental screw is implanted into the patient.

6. The method of claim 5, which further comprises before or after steps (iii) and (iv) introducing a bioactive compound, alone or in combination with a pharmaceutically acceptable carrier, into the core channel by way of the proximal end.

7. The method of claim 6, which further comprises connecting a dental prosthesis to the proximal end of the top portion.
